(19) United States
(12) Patent Application Publication
(10) Pub. No.: US 2016/0189171 A1
(43) Pub. Date: Jun. 30, 2016

(54) ANALYSING TOPICS IN SOCIAL NETWORKS

(71) Applicant: Crimson Hexagon, Inc., Boston, MA (US)

(72) Inventors: Christopher Bingham, Cambridge, MA (US); Aykut Firat, Cambridge, MA (US); Mitchell Brooks, Boston, MA (US); Francesco Liuzzi, Boston, MA (US); Avery Faller, Boston, MA (US); Pablo Funes, Cambridge, MA (US)

(21) Appl. No.: 14/585,514

(22) Filed: Dec. 30, 2014

(51) Int. Cl. G06Q 30/02; G06Q 50/00

(52) U.S. Cl. CPC G06Q 30/0201; G06Q 50/01

(57) ABSTRACT

Systems and methods are provided for analyzing social media content. In exemplary embodiments, the invention can include obtaining a plurality of data items communicated through at least one social media platform over a time interval, with each data item from the plurality of data items being associated with a time value within the time interval; analyzing at least a subset of the plurality of data items to assign each data item from the subset to a respective category from a plurality of categories; and generating for at least one category from the plurality of categories, a representation of data items assigned to the at least one category as a function of time over the time interval for presenting via a user interface.

### FIELD

This invention relates to the field of data mining systems. Exemplary embodiments relate to analyzing information communicated through social media platforms to detect trends. In particular, some embodiments relate to categorizing information generated over a time period and displaying a representation of one or more categories over the time period.

### BACKGROUND

Social networking has become a worldwide phenomenon and importance of social media is steadily and rapidly increasing. Millions of people communicate, share ideas, discuss news, current events, products, services and various other topics through different social media platforms. A social media platform, or service, enables a user to generate a piece of information, often referred to as a post, which can then be displayed on the social media web site where it can be viewed by other users. A post can include text, pictures, video or other information. Users can comment on the posts that they viewed, share it with their connections, or otherwise react to information in the post. Many users utilize social media services often—daily or even multiple times a day—and various themes can quickly become topics of active discussion as information spreads via a social network.

A wealth of information generated through social media platforms can be used for a variety of purposes. For example, marker researchers can monitor social networking sites in an attempt to identify users' views on various products, services and other topics. However, it may be challenging to extract meaningful information from the large volume of social networking posts. The analysis can be further complicated by the dynamic nature of social networking—topics and related users' views are ever-changing, and even the same user's opinion on a topic can change within a short time period. Thus, given the volume and complexity of social networking information, obtaining useful knowledge from it can be a daunting task.

### SUMMARY

Systems and methods of the present invention can help users discover interesting topics that are popular on social media. In some embodiments, the invention allows a user to filter documents based on content and time intervals. For example, FIG. 3 shows an analysis of social media content relating to THE GAP during a time period from November 2013 to January 2014. A user can apply an unsupervised clustering algorithm on the filtered data to discover clusters of documents relating to a particular topic. Discovered topics for the FIG. 3 example are listed in the table at the bottom of the Figure. These topics can then be analyzed to display changes in the content volume over time as illustrated in the graph of FIG. 3.

In one aspect, the invention provides a computer-implemented method comprising operating at least one computer processor to analyze information communicated through social media platforms.

The method includes obtaining, by the at least one computer processor, a plurality of data items communicated through at least one social media platform over a time interval. Each data item from the plurality of data items is associated with a time value within the time interval.

The method further includes analyzing, by the at least one computer processor, at least a subset of the plurality of data items to assign each data item from the subset to a respective category from a plurality of categories or topics.

The method further includes generating, by the at least one computer processor, for at least one category from the plurality of categories, a representation of data items assigned to the at least one category as a function of time over the time interval for presenting via a user interface.

Further methods, systems, and computer readable media having computer instructions thereon are provided.

### BRIEF DESCRIPTION OF THE DRAWINGS

FIG. 1 is a schematic diagram of one exemplary embodiment of a computer system useful with the invention;

FIG. 2 is a schematic diagram of one exemplary embodiment of an architecture for the systems and methods of the invention;

FIG. 3 is a diagram of an exemplary display output from the systems and methods of the invention;

FIG. 4 is a flow chart of an exemplary method of the invention; and

FIG. 5 is a flow chart of a further method of the invention.

### DETAILED DESCRIPTION OF THE INVENTION

Systems and methods are provided for analyzing topic content from a social media platform over time. In general, the systems and methods can include a topic discovery algorithm that can, from a set, or a filtered subset, group content from the social media platform into topics. These topics can be graphed over time, and those graphs can be analyzed to infer additional information about the topics.

A common technique in unsupervised text analysis is document clustering. Clustering uses an algorithm (of which there are many) to find groups of related documents. For example, clustering could be used to group news articles by theme (sports, economy, etc.). Since clustering is unsupervised, the user does not choose how the documents will be clustered—the algorithm does this automatically and thus the number and type of clusters may or may not be desirable.

Because clustering does not use a predetermined fixed definition for each document grouping, it is difficult for a user to track changes over time. If the user clusters the documents for today, and clusters the documents again tomorrow, the user will get different clusters each time, and the clusters will not have any correspondence from one time set to the next. There may be similar clusters for each day, but you cannot say that the clusters are actually the “same” as they will inevitably differ in many details.

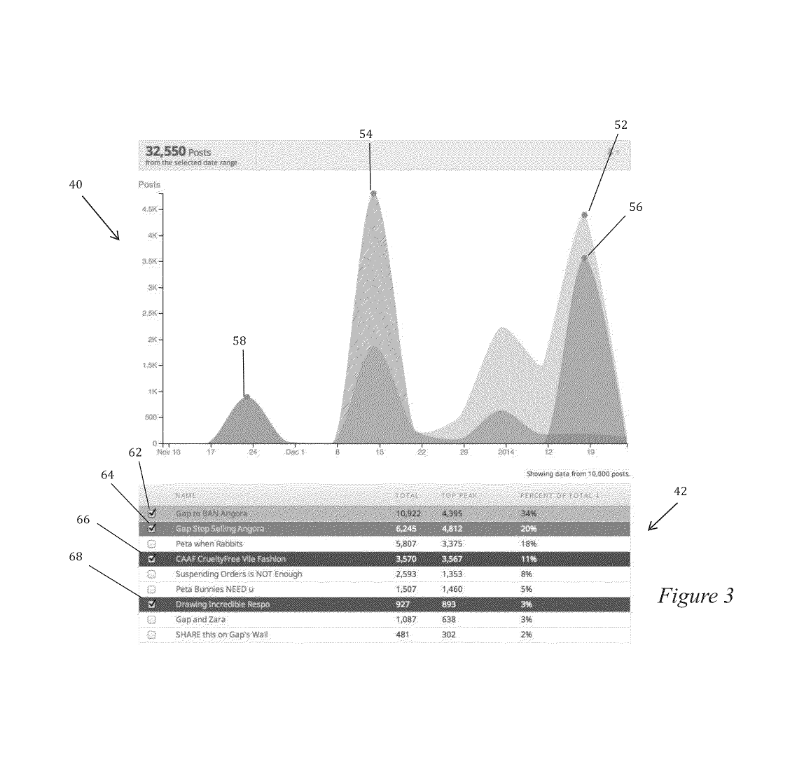

To improve on this state of affairs, the present invention can, in one embodiment, run clustering on documents from the entire time range rather than looking at time-based subsets separately. This creates a set of clusters, each of which contains documents across time. With this data, the invention can graph the volume of documents for each cluster over time, showing the user how different topics rise, fall, peak, or remain stable over time—information that is highly valuable and often as important as the cluster definitions themselves. The Example of FIG. 3 shows such a graph 40, and lists in the table 42 the clusters discovered.

Additionally, as the distribution of documents in each cluster over time is known, the invention can use this distribution to determine which clusters will be more interesting to a user. Clusters that are relatively stable are often less interesting, since they represent an ongoing topic that the user may already be aware of. Conversely, clusters that have notable peaks and other rapid changes are often very interesting, as they represent important events, emerging trends, and other changes that the user may not have seen before. Thus, the selection of document clusters based on time distribution patterns is a valuable analysis.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Computer Processor

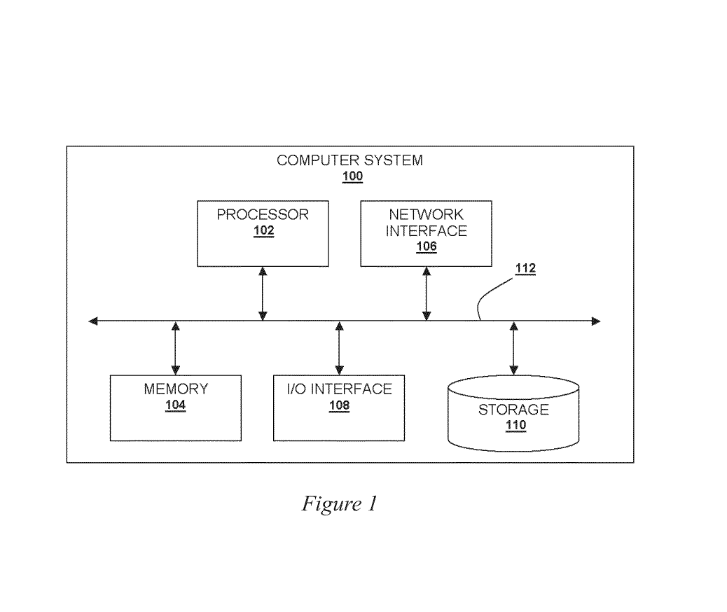

The systems and methods disclosed herein can be implemented using one or more computer systems, such as the exemplary embodiment of a computer system 100 shown in FIG. 1. As shown, the computer system 100 can include one or more processors 102 which can control the operation of the computer system 100. The processor(s) 102 can include any type of microprocessor or central processing unit (CPU), including programmable general-purpose or special-purpose microprocessors and/or any one of a variety of proprietary or commercially available single or multi-processor systems. The computer system 100 can also include one or more memories 104, which can provide temporary storage for code to be executed by the processor(s) 102 or for data acquired from one or more users, storage devices, and/or databases. The memory 104 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 100 can be coupled to a bus system 112. The illustrated bus system 112 is an abstraction that represents any one or more separate physical busses, communication lines/interfaces, and/or multi-drop or point-to-point connections, connected by appropriate bridges, adapters, and/or controllers. The computer system 100 can also include one or more network interface(s) 106, one or more input/output (IO) interface(s) 108, and one or more storage device(s) 110.

The network interface(s) 106 can enable the computer system 100 to communicate with remote devices (e.g., other computer systems) over a network, and can be, for example, remote desktop connection interfaces, Ethernet adapters, and/or other local area network (LAN) adapters. The IO interface(s) 108 can include one or more interface components to connect the computer system 100 with other electronic equipment. For example, the IO interface(s) 108 can include high speed data ports, such as USB ports, 1394 ports, etc. Additionally, the computer system 100 can be accessible to a human user, and thus the IO interface(s) 108 can include displays, speakers, keyboards, pointing devices, and/or various other video, audio, or alphanumeric interfaces. The storage device(s) 110 can include any conventional medium for storing data in a non-volatile and/or non-transient manner. The storage device(s) 110 can thus hold data and/or instructions in a persistent state (i.e., the value is retained despite interruption of power to the computer system 100). The storage device(s) 110 can include one or more hard disk drives, flash drives, USB drives, optical drives, various media cards, and/or any combination thereof and can be directly connected to the computer system 100 or remotely connected thereto, such as over a network. The elements illustrated in FIG. 1 can be some or all of the elements of a single physical machine. In addition, not all of the illustrated elements need to be located on or in the same physical or logical machine. Rather, the illustrated elements can be distributed in nature, e.g., using a server farm or cloud-based technology. Exemplary computer systems include conventional desktop computers, workstations, minicomputers, laptop computers, tablet computers, PDAs, mobile phones, and the like.

Although an exemplary computer system is depicted and described herein, it will be appreciated that this is for sake of generality and convenience. In other embodiments, the computer system may differ in architecture and operation from that shown and described here.

Modules

The various functions performed by the computer system 100 can be logically described as being performed by one or more modules. It will be appreciated that such modules can be implemented in hardware, software, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules is not a signal and can be stored as an executable program on one or more non-transitory computer-readable storage mediums. Functions disclosed herein as being performed by a particular module can also be performed by any other module or combination of modules.

Exemplary Architecture

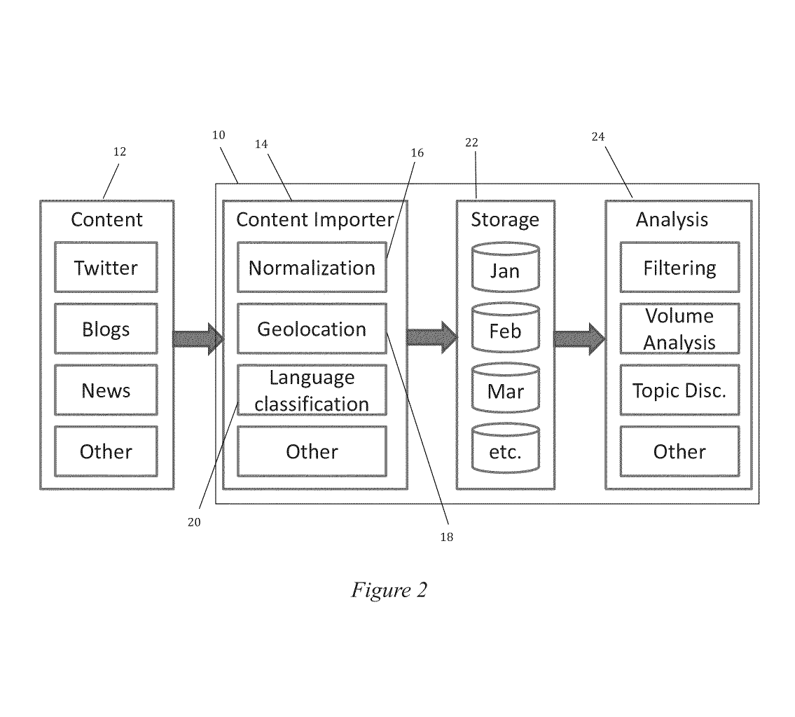

An exemplary system 10 for carrying out the invention is disclosed in FIG. 2. Here, content 12, such as social media content, and as specifically illustrated, content from TWITTER, blogs, news, and other social media or other content can be imported into system 10. Individual content items are sometimes referred to herein as “documents” or “posts.” In general, these posts are text inputs—that is, they include unstructured data. However, the invention can be applied just as well to structured data, such as data stored in spreadsheets or databases in a structured format, or to combinations of structured and unstructured data. A Content Importer 14 receives the documents and prepares them for analysis. In one exemplary pre-analysis step, the documents can be Normalized 16. Normalization 16 can include converting all the documents from diverse sources to a standardized set of fields, like contents, date, author, title, etc. Each data providers may have different names for its fields, or different ways of formatting the data. The goal of normalization is to store everything in a consistent way (the “normal” form) so that analysis can be performed on the documents without regard to their origin. Normalization could also include things like removing duplicates, removing posts that are spam or have bogus URLs, converting all dates to GMT, etc. The Content Importer can also tag posts with Geolocation 18 data. That is, where possible, the Content Importer can estimate, based on things like language, IP addresses, tags, or the post actually containing geolocation references, a location for the post and can tag the post with that location. In this way, analysis can also be geo-specific, so that analysis can be performed based on relevant geographical regions. Further, the Import Server can apply a Language Classifier 20 that can determine a language for a given post and tag the post with that language. As with location, this allows later analysis to be segregated based upon language. In addition, other types of pre-analysis may be performed on the content prior to storage for analysis according to the invention.

System 10 can also include computer storage 22 that stores imported content for analysis. In one embodiment, the content can be stored according to the time of its generation (illustrated in FIG. 2 as being stored according to month). Where the circumstances are such that the analysis is often date specific, arranging the content in storage according to date can allow for convenient and efficient retrieval of the content for analysis.

System 10 also includes an Analysis section 24. It is in the analysis section that the algorithms described below are employed to analyze content. Filtering can be an important part of any further analysis that is performed on the imported content. Filtering can be performed on key words, word stems, word vectors, and a variety of other content-based filtering techniques. Filtering can also be performed based on other metadata associated with the content, including location, language, and, most particularly, time. By filtering, a system of the invention can create a data set that relates to a particular content topic area, for example, over a specific time frame.

The analysis can include a volume analysis—such as how much content references the IPHONE 5. The analysis can further include a sentiment analysis—such as whether posters like or dislike the IPHONE 5. The analysis preferably includes poster opinion based upon categories selected by an analyst. The analysis section can include other types of analysis as well. Examples of sentiment/opinion analysis can be found in U.S. Pat. No. 8,180,717, filed on Mar. 19, 2008, and entitled “System for Estimating a Distribution off Message Content Categories in Source Data,” the contents of which are hereby incorporated by reference in their entirety.

The analysis can also include a topic discovery analysis. This topic discovery analysis, described in greater detail below, can analyze a content set, such as that generated by the filtering analysis, and discover topics within that content set having a pattern of activity over time.

The system 10 can include fewer or more modules than what is shown and described herein and can be implemented using one or more digital data processing systems of the type described above. The system 10 can be implemented on a single computer system, or can be distributed across a plurality of computer systems, e.g., across a “cloud.” The system 10 also includes a plurality of databases, which can be stored on and accessed by computer systems. It will be appreciated that any of the modules or databases disclosed herein can be subdivided or can be combined with other modules or databases.

Filtering Module

The filtering module can be used to create a subset of documents from all of the documents available to the system 10 for performing a topic analysis. One exemplary embodiment of the filtering module can be configured to search on keywords or word stems in the manner of known search engines that can perform content searching on on-line or private documents. The filtering module can also allow users to select from available social media platforms so that the user may analyze, for example, only TWEETS. The filtering module can further allow the user to specify a time or date range for the documents. The filtering module can still further allow the user to specify a preferred language or languages for the documents. The filtering module may further allow specification of any other data or metadata associated with the documents. When the filtering operation is performed on the collected documents in the system 10, a subset of documents having the desired characteristics is created and can be stored. This subset of desired documents can be used for further topic analysis.

Topic Discovery Module

Further topic analysis on the set or desired subset of documents can be performed by the topic discovery module. The topic discovery module can include an algorithm for grouping similar documents. In one embodiment, the topic discovery module includes a clustering algorithm. Clustering is the task of grouping a set of objects in such a way that objects in the same group (called a cluster) are more similar (in some sense or another) to each other than to those in other groups (clusters). Clustering can be achieved by various known algorithms. One exemplary clustering algorithm is described in T. Zhang et al., “BIRCH: An Efficient Data Clustering Method for Very Large Databases,” Proc. Int'l Conf. on Management of Data, ACM SIGMOD, pp. 103-114 (1996), which is hereby incorporated by reference in its entirety.

Once a clustering or other analysis has been performed on a subset of the documents, the clusters themselves can be analyzed. A typical topic discovery analysis can be done on a subset of documents that relate to a particular key word or concept over a specific period of time. The clustering analysis will group documents from this subset into clusters. Known algorithms can give names to these clusters so that a user can determine a topic for each cluster and understand how the clusters differ from each other.

In addition, the topic discovery module can perform a volume analysis on the clusters. The number of documents within a cluster, or the percentage of documents within the subset that fall within the cluster, can be useful metrics for determining which clusters to present to the user. For example, a threshold may be set for the number of documents in a particular cluster as a percentage of the total number of documents in the subset. By way of further example, clustered topics may be presented to the user where the cluster includes at least 2% of all of the documents within the subset.

The topic discovery module can also perform a time based volume analysis on the clusters. For example, the number of documents in a cluster can be determined on a timed basis within the time period on which the subset of documents is based. If the filtering includes a time based limitation corresponding to a 30 day month, the timed basis volume analysis could be a daily one. In this way, the topic discovery module could track the daily volume within a cluster over the 30 day period for the purpose of determining patterns in the volume of documents within the cluster over time. Clusters that have higher peaks—that is, a high volume of documents for a particular day, or a high percentage of documents on a particular day as compared to the total number of documents for the 30 day period, or a high volume of documents on a particular day as compared (for example as a multiple) of the lowest volume of documents for a day during the 30 day period—may be more interesting to users and thresholds may be set for the metrics of high peaks for presenting such clusters to users. Metrics tending to more than one peak can also be interesting. Such behavior can be determined using the same metrics as described earlier, but applying to two or more peaks in volume as opposed to one. In addition, high peak metrics could be used to order the clusters presented to a user for viewing.

Display Module

The display module can display the clusters and their contents over time in tabular and/or graphical form. FIG. 3 provides both a graphical 40 and tabular 42 illustration of a filtering/clustering result. More particularly, peaks 52, 54, 56, and 58 correspond to peaks for checked clusters 62, 64, 66, and 68 respectively. The tabular information includes the name of each cluster, the total volume for each cluster, the highest daily peak volume for each cluster, and the cluster's total volume as a percentage of the total volume for the filtered subset of documents.

In addition, the display module can provide interaction. For example, clicking on a peak could provide available statistics and metrics regarding that cluster. In addition, exemplary documents, such as documents that have hallmarks of being popular—such as the largest number of “likes” or “re-tweets”—can be displayed to give the user greater insight into the nature of the cluster.

Methods

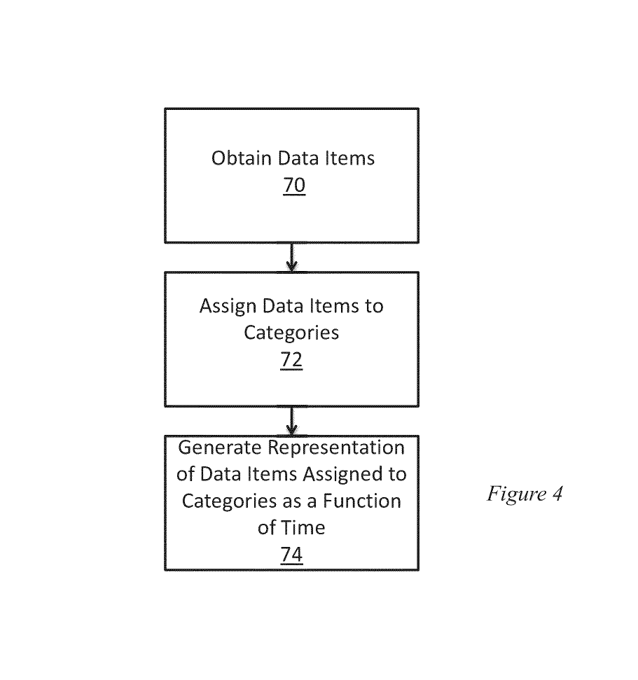

An exemplary method of the invention can be described with respect to FIG. 4. This method can be implemented on a computer as described above, preferably by programming the computer to perform the described steps. The purpose of the method is to analyze information communicated through social media platforms. The first step 70 in the method is to obtain a plurality of data items communicated through at least one social media platform over a time interval. Each data item, which can be any type of social media content (sometimes referred to as “documents” above) but preferably includes or can be processed to include text, is associated with a time value from within the time interval. In an exemplary embodiment, this step can be performed by the content importer, and optionally by the filtering module.

The next step 72 in the exemplary method of FIG. 4 is analyzing the data items to assign at least a subset of the data items to one of a plurality of categories. As noted above, in one embodiment, this step can be performed using an unsupervised clustering algorithm. In this way, the categories are not pre-set, but rather are created by the algorithm based upon the data items. In an exemplary embodiment, this step can be performed by the topic discovery module.

When the data items are clustered into categories, the next step 74 can involve generating a representation of data items assigned to at least one of the categories as a function of time. In an exemplary embodiment, this step can be performed by the display module.

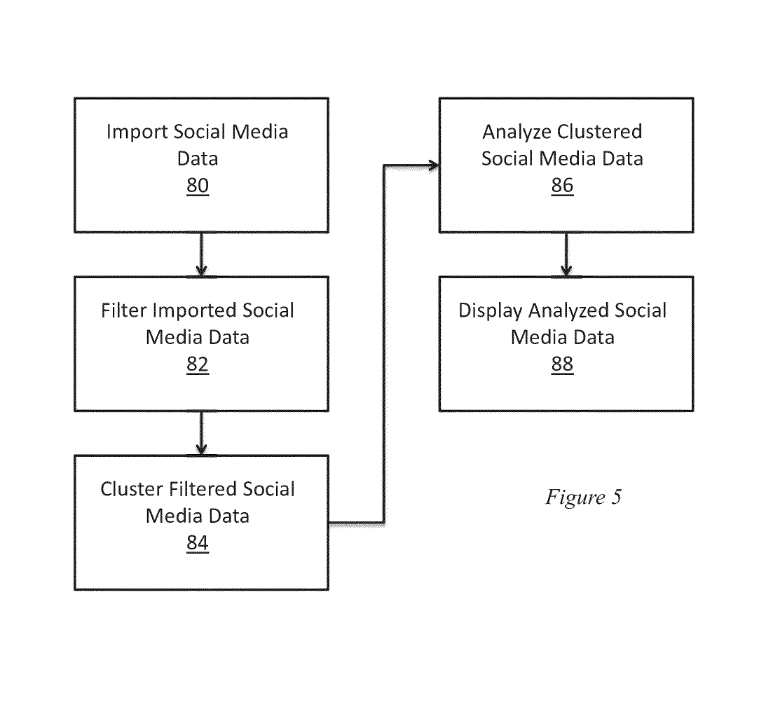

A further method of the invention is illustrated in FIG. 5. There, a computer-implemented method comprising operating at least one computer processor to analyze information communicated through social media platforms is provided.

The first step 80 in the method of FIG. 5 includes importing social media data items from at least one social media platform, the social media data items including a time value. Each data item, which can be any type of social media content (sometimes referred to as “documents” above) but preferably includes or can be processed to include text, is associated with a time value from within the time interval. In an exemplary embodiment, this step can be performed by the content importer.

The next step 82 includes filtering of the imported social media data items based at least on content and a time interval. The filtering can also include filtering to include or exclude one or more social media platforms, languages, or other metadata associated with the social media items. In an exemplary embodiment, this step can be performed by the filtering module.

A further step 84 in the method of FIG. 5 is clustering of the filtered social media data items over the time interval to create a plurality of categories with the filtered social media data items assigned to one of the plurality of categories. In a preferred embodiment, this is accomplished using an unsupervised clustering algorithm so that the categories can be discovered rather than predetermined. In an exemplary embodiment, this step can be performed by the topic discovery module.

The next step 86 in the method of FIG. 5 is analyzing the categories to determine a peak filtered social media data item volume based upon the time values of the filtered social media data items within the time interval. In an exemplary embodiment, this step can be performed by the topic discovery module.

The final illustrated step 88 in FIG. 5 is displaying the categories and peak filtered social media data item volumes in an order derived from the peak filtered social media data item volumes. In an exemplary embodiment, this step can be performed by the display module.

A person of ordinary skill in the art will appreciate further features and advantages of the invention based on the above-described embodiments and objectives. Accordingly, the invention is not to be limited by what has been particularly shown and described, except as indicated by the appended claims or those ultimately provided. All publications and references cited herein are expressly incorporated herein by reference in their entirety, and the invention expressly includes all combinations and sub-combinations of features included above and in the incorporated references.

What is claimed is:

1. A computer-implemented method comprising operating at least one computer processor to analyze information communicated through social media platforms, the method comprising:
obtaining, by the at least one computer processor, a plurality of data items communicated through at least one social media platform over a time interval, each data item from the plurality of data items being associated with a time value within the time interval;
analyzing, by the at least one computer processor, at least a subset of the plurality of data items to assign each data item from the subset to a respective category from a plurality of categories; and
generating, by the at least one computer processor, for at least one category from the plurality of categories, a representation of data items assigned to the at least one category as a function of time over the time interval for presenting via a user interface.

2. The method of claim 1, further comprising:
using, by the at least one computer processor, the representation to analyze a distribution over time of the data items assigned to the at least one category.

3. The method of claim 1, wherein:
the time value comprises a date and/or time when the data item is communicated through the at least one social media platform.

4. The method of claim 1, further comprising:
receiving first input instructing the at least one computer processor to obtain the plurality of data items; and
receiving second input specifying the time interval.

5. The method of claim 4, wherein:
at least one of the first input and second input comprises user input.

6. The method of claim 4, wherein:
the first input comprises at least one keyword.

7. The method of claim 1, wherein:
the representation comprises a first representation; and
the method further comprises generating, by the at least one computer processor, for at least one other category from the plurality of categories, a second representation of data items assigned to the at least one other category as a function of time over the time interval, wherein the second representation is different from the first representation.

8. The method of claim 1, further comprising:
analyzing the representation of each category of the at least one category to select a category indicating information of interest; and
presenting results of the analyzing of the representation on the user interface.

9. The method of claim 8, wherein:
the representation comprises a waveform; and
analyzing the representation comprises analyzing a shape of the waveform.

10. The method of claim 1, further comprising:
generating at least one annotation in association with the representation of the data items assigned to the at least one category, the at least one annotation comprising information on at least one data item of the data items.

11. The method of claim 1, wherein:
each category from the plurality of categories comprises data items related to a topic.

12. A computer system comprising:
memory storing computer-executable instructions;
at least one processor communicatively coupled to the memory and configured to execute the computer-executable instructions to perform a method of analyzing information communicated through social media platforms, the method comprising:
obtaining, by the at least one computer processor, a plurality of data items communicated through at least one social media platform over a time interval, each data item from the plurality of data items being associated with a time value within the time interval;
analyzing, by the at least one computer processor, at least a subset of the plurality of data items to assign each data items from the subset to a respective category from a plurality of categories; and
presenting on a user interface, by the at least one computer processor, for at least one category from the plurality of categories, a representation of data items assigned to the at least one category as a function of time over the time interval.

13. The computer system of claim 12, wherein:
the representation comprises a first representation; and
generating the representation further comprises generating, by the at least one computer processor, for at least one other category from the plurality of categories, a second representation of data items assigned to the at least one other category as a function of time over the time interval, wherein the second representation is different from the first representation.

14. The computer system of claim 12, wherein the method further comprises:
analyzing the representation of each category of the at least one category to select a category indicating information of interest.

15. The computer system of claim 14, wherein:
the information of interest comprises a trend.

16. A computer-implemented method comprising operating at least one computer processor to view representation of information communicated through social media platforms, the method comprising:
receiving, via a user interface, first user input instructing a computing device to obtain a plurality of data items communicated through at least one social media platform over a time interval, each data item from the plurality of data items being associated with a time value within the time interval, wherein the computing device is configured to analyze at least a subset of the plurality of data items to assign each data item from the subset to a respective category from a plurality of categories;
receiving, via a user interface, second user input instructing the computing device to generate, for at least one category from the plurality of categories, a representation of data items assigned to the at least one category as a function of time over the time interval for presenting via a user interface; and
displaying on the user interface the representation such that a first representation of data items assigned to a first category from the at least one category is different from a second representation of data items assigned to a second category from the at least one category.

17. A computer-implemented method comprising operating at least one computer processor to analyze information communicated through social media platforms, the method comprising:
importing, by the at least one computer processor, social media data items from at least one social media platform, the social media data items including a time value;
filtering, by the at least one computer processor, of the imported social media data items based at least on content and a time interval;
clustering, by the at least one computer processor, of the filtered social media data items over the time interval to create a plurality of categories with the filtered social media data items assigned to one of the plurality of categories;
analyzing, by the at least one computer processor, of the categories to determine a peak filtered social media data item volume based upon the time values of the filtered social media data items within the time interval; and
displaying, by the at least one computer processor, the categories and peak filtered social media data item volumes in an order derived from the peak filtered social media data item volumes.
